(19) United States
(12) Patent Application Publication
(10) Pub. No.: US 2026/0181494 A1
(43) Pub. Date: Jun. 25, 2026

(54) METHODS ON EARLY SRS TRANSMISSION FOR LTM IN FD SYSTEMS

(71) Applicant: InterDigital Patent Holdings, Inc., Wilmington, DE (US)

(72) Inventors: Nazli Khan Beigi, Longueuil (CA); Jonghyun Park, Syosset, NY (US); Moon IL Lee, Melville, NY (US); Paul Marinier, Brossard (CA); Aata El Hamss, Laval (CA); Virgile Garcia, Antibes (FR)

(73) Assignee: InterDigital Patent Holdings, Inc., Wilmington, DE (US)

(21) Appl. No.: 18/990,133

(22) Filed: Dec. 20, 2024

(51) Int. Cl. H04W 36/00; H04W 36/08

(52) U.S. Cl. CPC H04W 36/0072; H04W 36/08

(57) ABSTRACT

A wireless transmit/receive unit (WTRU) may be configured to receive a first message comprising a candidate cell identification (ID) and a synchronization signal block (SSB) configuration for a candidate cell, and configured to receive a second message that comprises a first set of SRS configurations, and configured to receive a third message over a physical downlink control channel (PDDCH) that may include SRS indications, and configured to determine a second set of SRS configurations based on the SRS indications in the third message and based on the target cell ID being different than a cell ID of the serving cell. The second set of SRS configurations may comprise at least an uplink spatial filter, an SRS power, and a timing advance. The WTRU may be configured to send, to a target cell, based on the third message, an SRS transmission, using the determined second set of SRS configurations.

### BACKGROUND

In RAN #102, a RAN work item on New Radio (NR) duplex operation has been agreed. This technology may be a foundation for improving conventional time division duplexing (TDD) operation by enhancing uplink (UL) coverage, improving capacity, and reducing latency, among others. The conventional TDD is based on splitting the time domain between the uplink and downlink. In NR Release. 19, the feasibility of allowing full duplex, or more specifically, subband non-overlapping full duplex (SBFD) at the gNB within a conventional TDD band is investigated.

### SUMMARY

A wireless transmit/receive unit (WTRU) may be configured to perform a method of sounding reference signal (SRS) transmission. The WTRU may be connected to a serving cell. The WTRU may be configured to receive a first message comprising at least a candidate cell identification (ID) and a synchronization signal block (SSB) configuration for a candidate cell. The WTRU may be configured to receive a second message that comprises a first set of SRS configurations. The WTRU may be configured to receive a third message over a physical downlink control channel (PDDCH) channel. The third message may comprise at least a target cell ID, an SRS resource ID, an uplink transmission configuration index (TCI) state, an indication of a timing advance (TA), and a synchronization signal block (SSB) index. The WTRU may be configured to determine a second set of SRS configurations based on the third message and based on the target cell ID being different than a cell ID of the serving cell. The second set of SRS configurations may comprise at least an uplink spatial filter, an SRS power, and a TA. The WTRU may be configured to send, to a target cell, based on the third message, an SRS transmission, using the determined second set of SRS configurations. The SRS transmission to the target cell may be performed before cell switching is performed. The WTRU may be configured to perform a L1/L2 mobility (LTM) cell switch, based on the received first message, subsequent to sending the SRS transmission to the target cell. The third message may comprise a request for the WTRU to send an SRS transmission to the target cell. The indication of a TA in the third message may comprise an indication to use a preconfigured TA value. The indication of a TA in the third message may comprise a codepoint to a TA value from a list of TA values. The indication of a TA in the third message may comprise a timing advance command (TAC) that indicates an absolute value of the TA. The uplink spatial filter may be determined based on an estimated path loss which may be based on the SSB index. The SRS power may be determined based on at least one of: the SSB index or the uplink TCI state. The determined TA in the second set of SRS configurations may be based on the indication of the TA in the received third message.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of a subband non-overlapping full duplex (SBFD) configuration in a time divisional duplexing (TDD) framework;

FIG. 3 shows an example procedure for L1/L2 triggered mobility (LTM) cell switching;

FIG. 4 shows an example scenario of WTRU-to-WTRU cross-link interference (CLI) in an LTM system;

FIG. 5 shows an example procedure for early sounding reference signal (SRS) transmission in an LTM system; and

FIG. 6 shows an example procedure for early SRS transmission in an LTM system.

### DETAILED DESCRIPTION

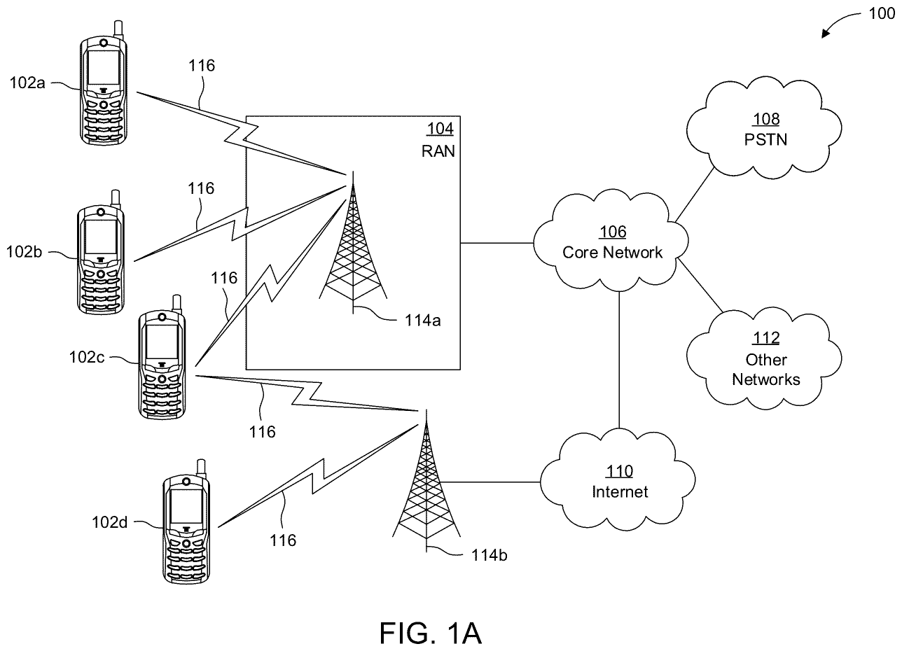

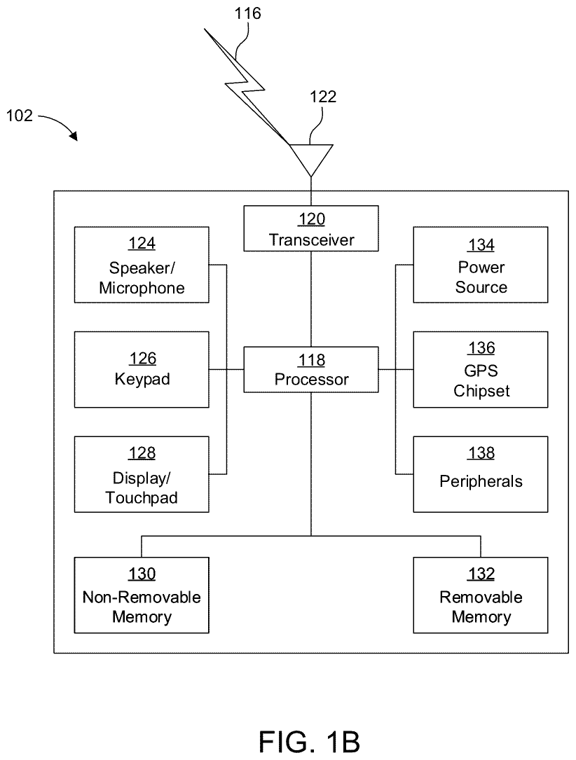

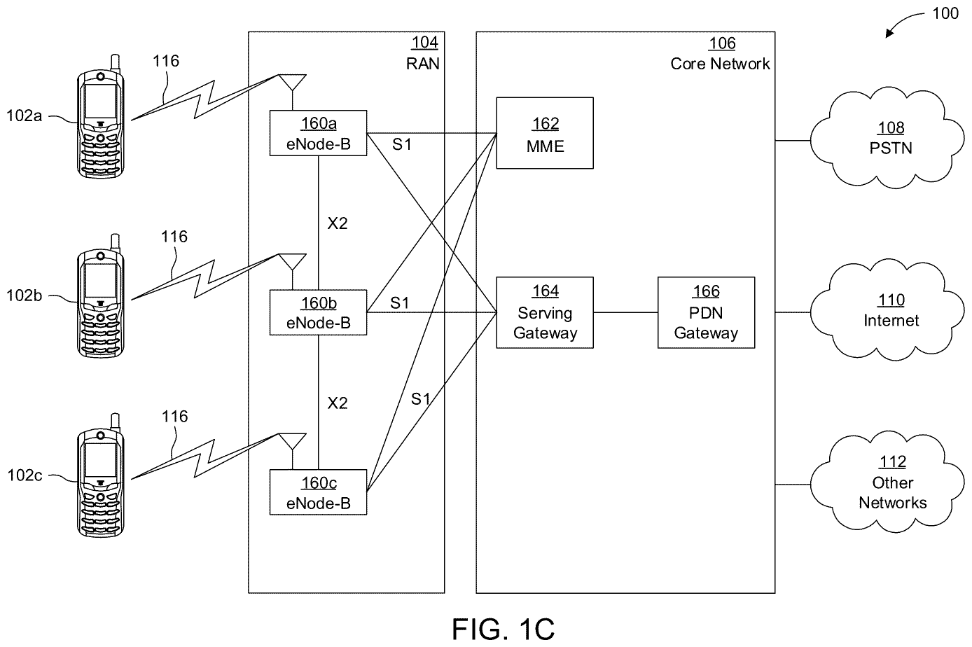

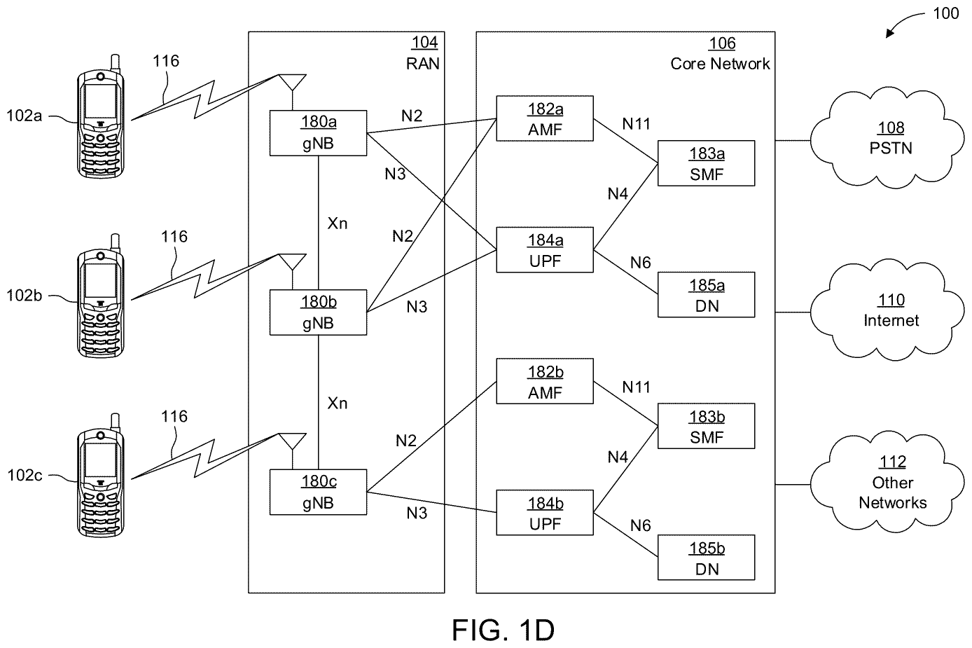

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, 6G etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

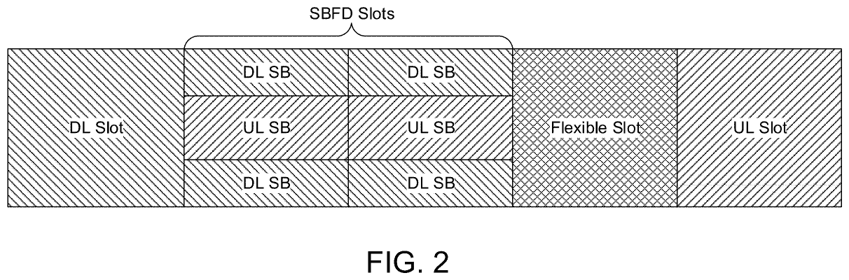

FIG. 2 show an example of a subband non-overlapping full duplex (SBFD) configuration in a TDD network, which includes a DL slot, SBFD slots, a flexible slot, and an UL slot. The SBFD slot is divided into non-overlapping subbands for DL (DL SB) and UL (UL SB).

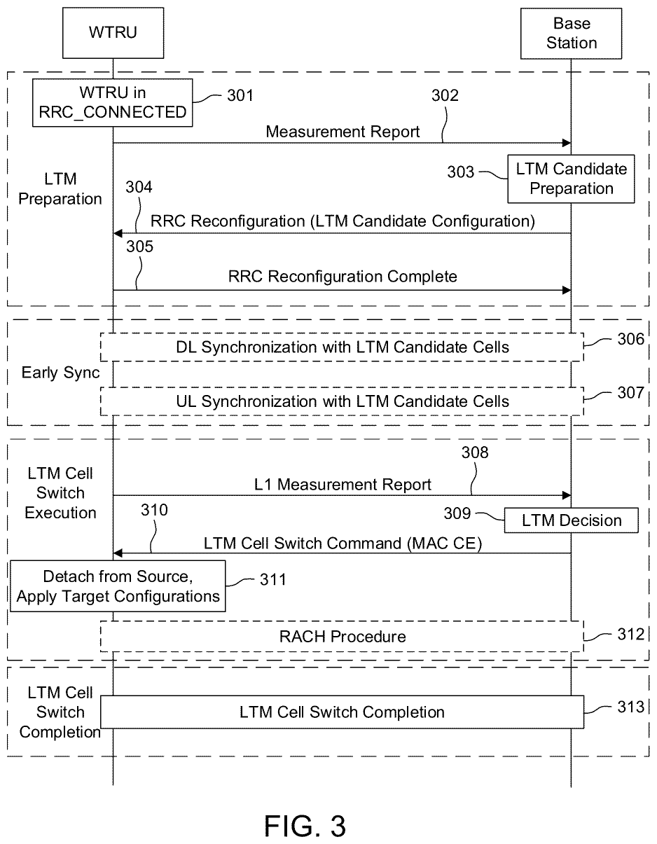

FIG. 3 shows an example procedure for L1/L2 triggered mobility (LTM) cell switching. In an LTM procedure, as shown in FIG. 3, a base station (BS) (e.g., gNB) may receive L1 measurement report(s) from a WTRU. Based on L1 measurement report(s), the BS may change the WTRU's serving cell using a cell switch command signaled via a MAC control element (CE). The cell switch command may indicate an LTM candidate configuration that the BS previously prepared and provided to the WTRU through radio resource control (RRC) signaling. The WTRU may switch to the target configuration based on the cell switch command. The signaling procedure for LTM cell switching may be based on the following steps where the WTRU may report measurements to the BS as part of an L1 measurement report. The WTRU may perform cell switching after receiving an LTM cell switch command in LTM or after one or more conditions or events are satisfied in conditional LTM. The WTRU may be indicated (e.g. receive an indication) to perform a random access channel or procedure (RACH)-less or RACH-based procedure to connect to a candidate cell, resulting in LTM cell switch completion. When configured by the network, it may be possible to activate transmission configuration index (TCI) states of one or multiple cells that are different from the current serving cell. For example, the TCI states of the LTM candidate cells may be activated in advance before any of those cells become the serving cell.

A WTRU may be in an RRC_Connected mode or state 301. The WTRU may send a measurement report 302 to a BS. The BS may receive the measurement report and perform LTM candidate preparation 303. The BS may send an RRC reconfiguration message that indicates LTM candidate configuration 304 to the WTRU. The WTRU may send an RRC reconfiguration complete message 305 to the BS. The steps 301-305 may be referred to LTM preparation.

An early synchronization may be performed which may comprise DL synchronization with LMT candidate cells 306 and UL synchronization with LMT candidate cells 307.

The WTRU may send an L1 measurement report 308 to the BS. The BS may receive the L1 measurement report and perform an LTM decision 309. The BS may send an LTM cell switch command, which may be sent in a MAC CE, 310 to the WTRU. The WTRU may detach from the source cell and apply target configurations 311. A RACH procedure may be performed 312. Steps 308-312 may be referred to as LTM cell switch execution.

An LTM cell switch completion may be performed 313.

A WTRU may determine the sounding reference signal (SRS) power for transmitting an SRS. The following is an example method for measuring SRS. These examples are non-limiting examples of the SRS configurations and parameters. One or more of those configurations may be included. Other configurations may be included.

If a WTRU transmits SRS based on a configuration by SRS-ResourceSet on active UL BWP b of carrier f of serving cell c using SRS power control adjustment state with index l, the WTRU determines the SRS transmission power P_{SRS,b,f,c} (i,qₛ,l) in SRS transmission occasion i as

$${P}_{SRS , b , f , c} ( i , {q}_{s} , l ) = min \{ \begin{matrix}{P}_{CMAX , f , c} ( i ) , \\ {P}_{O\_SRS , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot {PL}_{b , f , c} ( {q}_{d} ) + {h}_{b , f , c} ( i , l )\end{matrix} \} [ dBm ]$$

where,
   P_{CMAX,f,c} (i) is the WTRU configured maximum output power defined in [8, TS 38.101-1], [8-2, TS 38.101-2] and [TS 38.101-3] for carrier f of serving cell c in SRS transmission occasion i
   P_{O_SRS,b,f,c} (qₛ) is provided by p0 for active UL BWP b of carrier f of serving cell c and SRS resource set qₛ provided by SRS-ResourceSet and SRS-ResourceSetId
   M_{SRS,b,f,c} (i) is a SRS bandwidth expressed in number of resource blocks for SRS transmission occasion i on active UL BWP b of carrier f of serving cell c and u is a SCS configuration defined in [4, TS 38.211]
   α_{SRS,b,f,c} (qₛ) is provided by alpha for active UL BWP b of carrier f of serving cell c and SRS resource set qₛ
   PL_{b,f,c} (q_{d}) is a downlink pathloss estimate in dB calculated by the WTRU using RS resource index q as described in clause 7.1.1 for the active DL BWP of serving cell c and SRS resource set qₛ [6, TS 38.214]. The RS resource index q_{d} is provided by pathlossReferenceRS associated with the SRS resource set qₛ and is either an ssb-Index providing a SS/PBCH block index or a csi-RS-Index providing a CSI-RS resource index. If the WTRU is provided enablePL-RS-UpdateForPUSCH-SRS, a MAC CE [11, TS 38.321] can provide by SRS-PathlossReferenceRS-Id a corresponding RS resource index q_{d} for aperiodic or semi-persistent SRS resource set qₛ
      If the WTRU is not provided pathlossReferenceRS or SRS-PathlossReferenceRS-Id and if the WTRU is not provided enableDefaultBeamPL-ForSRS, or before the WTRU is provided dedicated higher layer parameters, the WTRU calculates PL_{b,f,c} (q_{d}) using a RS resource obtained from an SS/PBCH block with same SS/PBCH block index as the one the WTRU uses to obtain MIB, or using the SS/PBCH block the WTRU acquired the time and frequency synchronization for a secondary cell.
      If the UE is provided pathlossReferenceLinking, the RS resource is on a serving cell indicated by a value of pathlossReferenceLinking
      If the WTRU
         is not provided pathlossReferenceRS or SRS-PathlossReferenceRS-Id,
         is not provided spatialRelationInfo, and
         is provided enableDefaultBeamPL-ForSRS, and
         is not provided coresetPoolIndex value of 1 for any CORESET, or is provided coresetPoolIndex value of 1 for all CORESETs, in ControlResourceSet and no codepoint of a TCI field, if any, in a DCI format of any search space set maps to two TCI states [5, TS 38.212]
      the WTRU determines a RS resource index q_{d} providing a periodic RS resource configured with qcl-Type set to ‘typeD’ in
         the TCI state or the QCL assumption of a CORESET with the lowest index in the active DL BWP, if CORESETs are provided in the active DL BWP of serving cell c. If the CORESET has two activated TCI states, as described in clause 10.1, the WTRU determines the RS resource index q_{d} based on the first TCI state.
         the active PDSCH TCI state with lowest ID [6, TS 38.214] in the active DL BWP, if CORESETs are not provided in the active DL BWP of serving cell c.

Some progress has been made to date with regards to SRS transmission for the purpose of WTRU-to-WTRU cross-link interference (CLI) measurement in SBFD systems, with the following agreements and working assumptions being made in 3GPP RAN1.

For separate SRS configurations for SBFD and non-SBFD symbols, support Option 1.

Option 1: Support separate SRS-ResourceSets configurations for SBFD and non-SBFD symbols for a given usage.
SRS-ResourceSet configured for SBFD symbol is only applicable to SRS transmission occasions in SBFD symbols.
   For periodic and semi-persistent SRS, the SRS transmissions in non-SBFD symbols are dropped.
   For aperiodic SRS with available slot counting, only SBFD symbols are available for SRS transmission.
      FFS impact on availableSlotOffsetList.
   For aperiodic SRS without available slot counting, it is expected that UE is indicated to transmit SRS in the SBFD symbols.
   FFS: whether there is impact on frequency hopping counter
SRS-ResourceSet configured for non-SBFD symbol is only applicable to SRS transmission occasions in non-SBFD symbols.
   For periodic and semi-persistent SRS, the SRS transmissions in SBFD symbols are dropped.
   For aperiodic SRS with available slot counting, only non-SBFD symbols are available for SRS transmission.
      FFS impact on availableSlotOffsetList
   For aperiodic SRS without available slot counting, it is expected that UE is indicated to transmit SRS in the non-SBFD symbols.
   FFS: whether there is impact on frequency hopping counter.
The number of SRS resources in a SRS-ResourceSet for SBFD symbols is the same as the number of SRS resources in a SRS-ResourceSet for non-SBFD symbols for the same usage.

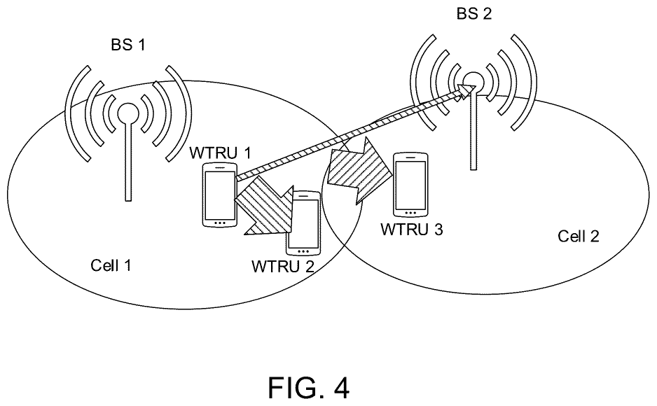

FIG. 4 show an example scenario of WTRU-to-WTRU cross-link interference (CLI) in an LTM system.

In full-duplex (FD) systems (e.g., SBFD systems) the LTM cell switching may result in WTRU-to-WTRU cross-link interference (CLI). The CLI may be caused by the WTRU that is performing the LTM cell switching and the CLI may be caused on the WTRUs in the target cell as well as the WTRUs in the serving cell. That is, a WTRU that uses a second beam direction to perform RACH or uplink transmission towards the target cell before or after LTM cell switching, may put other WTRUs at risk of WTRU-to-WTRU CLI. If the source of CLI is not detected, the CLI may cause unwanted performance degradation for other WTRUs. For example, as shown in FIG. 4, WTRU 1, that has performed cell switching from Cell 1 to Cell 2, may cause CLI to WTRU 2 and WTRU 3.

In NR, Release 18, an SRS-Config information is used for configuring SRS transmission configurations, however, the configuration information is configured with regards to the serving cell. Also, the SRS configuration is semi-statically configured, whereas LTM is a dynamic operation based on L1-measurements and low-latency signaling.

A problem is how may a potential CLI, via the WTRU performing LTM cell switching, be measured.

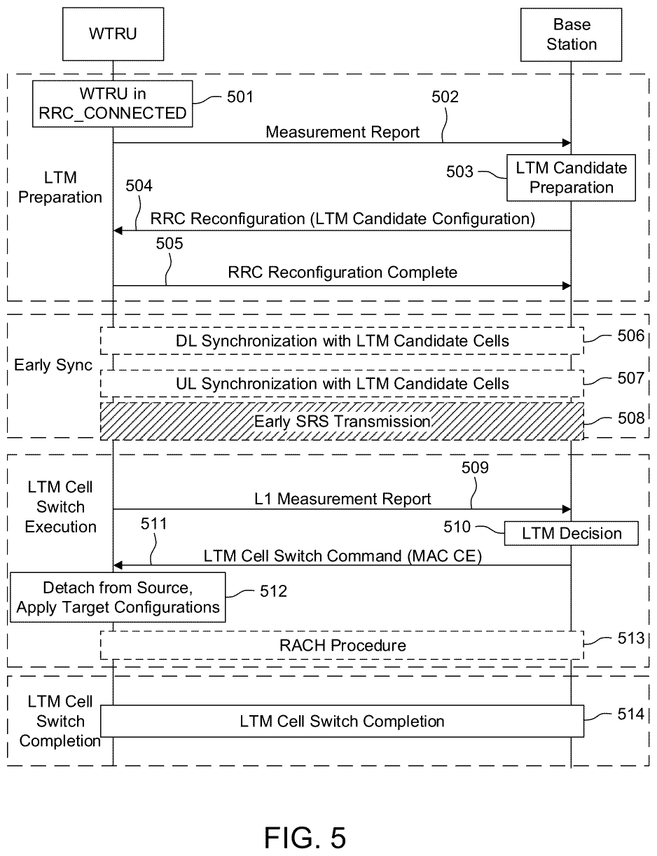

In an embodiment, a WTRU may perform a procedure for early SRS transmission in an LTM system, for example as shown in FIG. 5.

FIG. 5 shows an example procedure for early SRS transmission in an LTM system. A WTRU may be in an RRC_Connected mode or state 501. The WTRU may send a measurement report 502 to a base station (BS) (e.g., gNB). The BS may receive the measurement report and perform LTM candidate preparation 503. The BS may send and the WTRU may receive an RRC reconfiguration message that indicates LTM candidate configuration 504. The WTRU may send an RRC reconfiguration complete message 505 to the BS. The steps 501-505 may be referred to LTM preparation. An early synchronization may be performed which may comprise DL synchronization with LMT candidate cells 506 and UL synchronization with LMT candidate cells 507. An early SRS transmission procedure may be performed 508. The WTRU may send an L1 measurement report 509 to the BS. The BS may receive the L1 measurement report and perform an LTM decision 510. The BS may send an LTM cell switch command, which may be sent in a MAC CE, 511 to the WTRU. The WTRU may detach from the source cell and apply target configurations 512. A RACH procedure may be performed 513. Steps 509-513 may be referred to as LTM cell switch execution. An LTM cell switch completion may be performed 514.

In an embodiment, a WTRU may use a first beam direction towards its serving cell and may use a second beam direction towards a target cell as part of an LTM cell switching procedure.

A problem is that in SBFD systems, a WTRU that has performed LTM cell switching may cause CLI on or towards other WTRUs due to UL transmission or physical random access channel (PRACH) transmission in the target cell due to using the second beam direction towards the target cell. Also, SRS transmission is a semi-static procedure in NR, whereas LTM events are based on dynamic and L1 measurements. There is a need to mitigate CLI in LTM cell switching.

In an embodiment, a WTRU may receive one or more dynamic indications via, for example, a PDCCH order, as part of LTM cell switching. The dynamic indications may include a dynamic SRS configuration(s), for example, the PDCCH order may be bundled/linked/associated with an SRS transmission. The PDCC order may include a request to transmit an indicated SRS (e.g. via an SRS resource ID). If the WTRU does not receive the dynamic SRS configurations via the PDCCH order and only receives a request (e.g. from a base station (BS) (e.g., gNB) via the PDCCH order) to transmit a configured SRS (e.g., via an SRS ID), the WTRU may use a (pre) configured first set of SRS configurations for the SRS transmission. If the WTRU receives the dynamic SRS configurations (e.g. a second (sub) set of SRS configurations such as, for example, SRS power, UL TCI state, TA value) via the PDCCH order in addition to the request to transmit a configured SRS (e.g., via SRS resource ID), the WTRU may not use or discard the (pre) configured first SRS configurations and use a second set of SRS configurations for the SRS transmission, based on the dynamic indications in the PDCCH order. Upon reception of the PDCCH order, if an indicated cell-ID is different from the cell-ID of the WTRU's serving cell, the WTRU may determine the second set of configurations based on the dynamic indications, for example, a second TCI-state, a second SRS power, a second TA, for example as in Step 508 in FIG. 5.

A benefit of the early SRS transmission is that the transmitted SRS may be used for CLI measurement and reporting by one or more WTRUs in the target cell, enabling the network to mitigate potential CLI in advance.

A WTRU may receive one or more configuration information (e.g., via RRC) regarding one or more candidate cells for a LTM cell switching procedure. The WTRU may receive the indications to measure and report one or more L1-measurements based on, for example SSBs, from one or more candidate cells.

The WTRU may receive one or more configuration information (e.g., via RRC) regarding one or more SRS resources and/or SRS resource sets. The configuration information regarding one or more SRS resources and/or SRS resource sets may include, for example, an SRS resource ID, time and frequency resources, transmission comb, periodicity, slot offset, a first power control configuration, a first TCI state, and/or a first SSB index.

The WTRU may receive a PDCCH order (e.g., via downlink control information (DC)I) indicating a target cell ID, in addition to an SRS request field indicating the triggered SRS resource ID, TA value, a second SSB index and/or a second UL TCI-state.

If the indicated target cell ID is different from the serving cell ID, the WTRU may determine to use a second set of configurations for SRS transmission:

The WTRU may use the indicated second SSB index and the second UL TCI state for determining a second UL spatial filter.

The WTRU may determine a second SRS power control using the second SSB index and/or the L1 measurements (e.g., measured reference signal received power (RSRP) for determining a second path loss estimation.

The WTRU may determine a second TA to be used. If no indications regarding the TA is provided, the WTRU may determine the TA to be a (pre) configured default value (e.g., TA=0). If a codepoint is provided, the WTRU may determine the TA according to a (pre) configured list of TA values. If a TA absolute value is provided, the WTRU may use the provided TA absolute value.

The WTRU may send an SRS based on the indicated SRS resource, determined TA, determined power, and the determined UL spatial filter.

Hereinafter, ‘a’ and ‘an’ and similar phrases may be interpreted as ‘one or more’ or ‘at least one’. Similarly, any term which ends with the suffix ‘(s)’ may be interpreted as ‘one or more’ or ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

A WTRU may transmit or receive a physical channel transmission or reference signal according to at least one spatial domain filter. The term “beam” may be used to refer to a spatial domain filter.

The WTRU may transmit a physical channel transmission or signal using the same spatial domain filter as the spatial domain filter used for receiving an RS (such as CSI-RS) or a SS block. The WTRU transmission may be referred to as “target”, and the received RS or SS block may be referred to as “reference” or “source”. In such a case, the WTRU may be said to transmit the target physical channel transmission or signal according to a spatial relation with a reference to such RS or SS block.

The WTRU may transmit a first physical channel transmission or signal according to the same spatial domain filter as the spatial domain filter used for transmitting a second physical channel transmission or signal. The first and second transmissions may be referred to as “target” and “reference” (or “source”), respectively. In such a case, the WTRU may be said to transmit the first (target) physical channel transmission or signal according to a spatial relation with a reference to the second (reference) physical channel transmission or signal.

A spatial relation may be, for example, implicit, configured by RRC or signaled by a MAC CE or DCI. For example, a WTRU may implicitly transmit a PUSCH transmission and demodulation reference signal (DM-RS) of the PUSCH according to the same spatial domain filter as an SRS indicated by an SRS resource indicator (SRI) indicated in a DCI or configured by RRC. In an example, a spatial relation may be configured by RRC for an SRI or signaled by a MAC CE for a PUCCH. Such spatial relation may also be referred to as a “beam indication”.

The WTRU may receive a first (target) downlink channel transmission or signal according to the same spatial domain filter or spatial reception parameter as a second (reference) downlink channel transmission or signal. For example, such association may exist between a physical channel such as a PDCCH or PDSCH and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may receive an indication of an association between a CSI-RS or SS block and a DM-RS by an index to a set of TCI states configured by RRC and/or signaled by a MAC CE. Such indication may also be referred to as a “beam indication”.

Hereafter, a TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), and still consistent with this disclosure. Hereafter, Multi-TRP may be interchangeably used with one or more of MTRP, M-TRP, and multiple TRPs, and still consistent with this disclosure.

Hereinafter, the term “subband” and/or “sub-band” may be used to refer to a frequency-domain resource and may be characterized by at least one of the following: a set of resource blocks (RBs); a set of resource block sets (RB sets), for example, when a carrier has intra-cell guard bands; a set of interlaced resource blocks; a bandwidth part, or portion thereof; and/or a carrier, or portion thereof. For example, a subband may be characterized by a starting RB and number of RBs for a set of contiguous RBs within a bandwidth part. A subband may also be defined by the value of a frequency-domain resource allocation field and bandwidth part index.

Hereinafter, the term “XDD” may be used to refer to a subband-wise duplex (e.g., either UL or DL being used per subband) and may be characterized by at least one of the following: Cross Division Duplex (e.g., subband-wise FDD within a TDD band); subband non-overlapping full duplex (SBFD); subband-based full duplex (e.g., full duplex as both UL and DL are used/mixed on a symbol/slot, but either UL or DL being used per subband on the symbol/slot); frequency-domain multiplexing (FDM) of DL/UL transmissions within a TDD spectrum; a full duplex other than a same-frequency (e.g., spectrum sharing, subband-wise-overlapped) full duplex; or an advanced duplex method, for example, other than (pure) TDD or FDD.

Hereinafter, the term “dynamic (/flexible) TDD” may be used to refer to a TDD system/cell which may dynamically (and/or flexibly) change/adjust/switch a communication direction (e.g., a downlink, an uplink, or a sidelink) on a time instance (e.g., slot, symbol, or subframe). In an example, in a system employing dynamic/flexible TDD, a component carrier (CC) or a bandwidth part (BWP) may have one single type among downlink ‘D’, uplink ‘U’, and flexible ‘F’ on a symbol/slot, based on an indication by a group-common (GC)-DCI (e.g., format 2_0) comprising a slot format indicator (SFI), and/or based on tdd-UL-DL-config-common/dedicated configurations. On a given time instance/slot/symbol, a first network entity, for example a base station (BS) (e.g., gNB, cell, TRP) employing dynamic/flexible TDD may transmit a downlink signal to a first WTRU being communicated/associated with the first BS based on a first SFI and/or tdd-UL-DL-config configured/indicated by the first BS. A second BS (e.g., cell, TRP) employing dynamic/flexible TDD may receive an uplink signal transmitted from a second WTRU being communicated/associated with the second BS based on a second SFI and/or tdd-UL-DL-config configured/indicated by the second BS. In an example, the first WTRU may determine that the reception of the downlink signal is being interfered by the uplink signal, where the interference caused by the uplink signal may refer to a WTRU-to-WTRU cross-layer interference (CLI).

A WTRU may be operating during at least one of the one or more RRC states and/or RRC modes, for example including an RRC-Connected state, an RRC-Inactive state, and/or an RRC-Idle state.

A WTRU may be operating in an RRC-Connected state, during which the WTRU may have connected and established RRC context, and/or have at least one RRC connection, for example, to one or more cells, base stations, gNBs, or TRPs. In an RRC-Connected state, the WTRU may receive RRC context and/or one or more configuration information at least including, for example, one or more radio bearers, logical channels, PDU sessions, and/or security information. During the RRC-Connected state, the connected WRU may measure, for example, one or more reference signal received power (RSRP), reference signal received quality (RSRQ), and/or received signal strength indicator (RSSI) based on one or more received, detected, configured, and/or indicated reference signals (RSs) received from a serving cell and/or one or more neighboring cells. The connected WTRU may report the measured parameters, for example to the serving cell.

A WTRU may be operating in an RRC-Idle state, which may be the initial mode when the WTRU is powered up. The WTRU in the RRC-Idle state is in a dormant state where the WTRU is not actively engaged in communication. The WTRU in the RRC-Idle state may perform cell selection and/or cell reselection, where the WTRU may receive, detect, measure, and/or select a synchronization signal block (SSB), based on which the WTRU may use, for example, a PBCH, MIB, and/or SIB. The WTRU in the RRC-Idle state may monitor a PDCCH (e.g., DCI, Format 1-0 using a paging radio network temporary identifier (P-RNTI)) defined by a discontinuous reception (DRX) pattern. The WTRU may use a respective 5G-S-TMSI to receive paging messages in the RRC-Idle state.

A WTRU may be operating in an RRC-Inactive state, where the WTRU may keep the RRC context and core network connection and may not release the RRC when switching from an RRC-Connected state to an RRC-Inactive state. The WTRU in the RRC-Inactive state may be in a sleep mode, similar to an RRC-Idle state, where the mobility may be handled through cell reselection without involvement of the network.

A WTRU may receive one or more indications, for example, via one or more DCI. In an example, a WTRU may receive a DCI format 1_0. If the cyclic redundancy check (CRC) of the DCI format 1_0 is scrambled by a paging radio network temporary identifier (C-RNT)I and the frequency domain resource assignment field are of all ones, the DCI format 1_0 may be for a random access procedure initiated by a PDCCH order, with all remaining fields set as follows. These examples are non-limiting examples of the PDCCH order configurations and parameters that may be included in PDCCH-order configurations. One or more of those configurations may be included. Other configurations may be included.

The PDCCH order configuration may comprise one or more of the following:
Random Access Preamble index-6 bits according to ra-PreambleIndex in Clause 5.1.2 of [8, TS38.321]: if the value of the “Random Access Preamble index” is all zeros, random-access is based on CBRA.
UL/SUL indicator-1 bit.
   If the Cell indicator field is absent or the Cell indicator field indicates serving cell, if the value of the “Random Access Preamble index” is not all zeros and if the UE is configured with supplementaryUplink in ServingCellConfig in the cell, this field indicates which UL carrier in the cell to transmit the PRACH according to Table 7.3.1.1.1-1;
   If the Cell indicator field indicates a candidate cell, if the value of the “Random Access Preamble index” is not all zeros and if the UE is configured with Itm-EarlyUL-SyncConfigSUL in LTM-Candidate for the candidate cell, this field indicates which UL carrier in the candidate cell to transmit the PRACH according to Table 7.3.1.1.1-1;
   Otherwise, this field is reserved.
SS/PBCH index-6 bits. If the value of the “Random Access Preamble index” is not all zeros, this field indicates the SS/PBCH that shall be used to determine the RACH occasion for the PRACH transmission; otherwise, this field is reserved.
PRACH Mask index-4 bits. If the value of the “Random Access Preamble index” is not all zeros, this field indicates the RACH occasion associated with the SS/PBCH indicated by “SS/PBCH index” for the PRACH transmission, according to Clause 5.1.1 of [8, TS38.321]; otherwise, this field is reserved
Cell indicator—indicating the cell for the corresponding PRACH transmission if the UE is configured with higher layer parameter EarlyUISyncConfig, where C is the number of candidate cells configured with higher layer parameter EarlyUISyncConfig; 0 bit otherwise. The bit field index 0 of the cell indicator field is mapped to the serving cell, and other bit field indexes are mapped to the candidate cells configured with higher layer parameter EarlyUISyncConfig according to an ascending order of a candidate identity configured by Itm-Candidateld, with the bit field index 1 mapped to the candidate cell with the smallest candidate identity.
PRACH association indicator-0 or 1 bit.
   1 bit if the UE is provided with tag2-Id, and the UE is not provided coresetPoolIndex or is provided coresetPoolIndex with value 0 for the first CORESETs, and is provided coresetPoolIndex with value 1 for the second CORESETs. This field is reserved if the cell indicated by Cell indicator field is a candidate cell.
      This field indicates the PCI associated with the PRACH transmission if the UE is provided SSB-MTC-AddtionalPCI. The bit field index 0 of this field is mapped to the PCI of the serving cell, and the bit field index 1 of this field is mapped to the additional PCI associated with active TCI states.
      This field indicates the PL-RS for the PRACH transmission if the UE is not provided SSB-MTC-AddtionalPCI. The bit field index 0 of this field is mapped to the DL RS that the DM-RS of the PDCCH order is quasi-collocated with, and the bit field index 1 of this field is mapped to the SS/PBCH indicated by the SS/PBCH index field in this DCI format.
   0 bit otherwise.
PRACH retransmission indicator-0 or 1 bit.
   1 bit if the UE is configured with higher layer parameter EarlyUISyncConfig. This field indicates initial transmission or retransmission of PRACH according to Table 7.3.1.2.1-3 if the cell indicated by Cell indicator field is a candidate cell, and this field is reserved if the cell indicated by Cell indicator field is a serving cell but not a candidate cell.
   0 bit otherwise.
Reserved bits-a number of bits as determined by the following:
   (12-Y_1-Y_2) bits for operation in a cell with shared spectrum channel access in frequency range 1 or when the DCI format is monitored in common search space for operation in a cell in frequency range 2-2;
   (10-Y_1-Y_2) bits otherwise;
where,
   Y_1=0 if the UE is not configured with higher layer parameter EarlyUISyncConfig; Y_1=┌ [symbol] log [symbol] _2(C+1)┐+1 otherwise.
   Y_2=0 if the “PRACH association indicator” field is not present in this DCI format; Y_2=1 otherwise.

Hereafter, downlink reception may be used interchangeably with Rx occasion, PDCCH, PDSCH, SSB reception, and still consistent with this disclosure. Hereafter, uplink transmission may be used interchangeably with Tx occasion, PUCCH, PUSCH, PRACH, SRS transmission, and still consistent with this disclosure. Herein, time instance, slot, symbol, and subframe may be used interchangeably, and still consistent with this disclosure. Herein, UL-only and DL-only Tx/Rx occasions may be interchangeably used with legacy TDD UL or legacy TDD DL, respectively, and still consistent with this disclosure. In an example, the legacy TDD UL transmission or legacy DL reception occasions are the cases where SBFD is not configured and/or where SBFD is disabled.

Hereinafter, the terms received signal power, received signal energy, received signal strength, SSB EPRE, CSI EPRE, RSRP, RSSI, SINR, RSRQ, SS-RSRP, SS-RSSI, SS-SINR, SS-RSRQ, CSI-RSRP, CSI-RSSI, CSI-SINR, and CSI-RSRQ may be used interchangeably, and still consistent with this disclosure. Herein, the term CLI may be used interchangeably with interference, and still consistent with this disclosure.

Herein, the term non-SBFD may be used interchangeably with operation without SBFD, TDD, legacy TDD, and still consistent with this disclosure. Herein, the terms ‘paired spectrum’ and FDD may be used interchangeably, and still consistent with this disclosure. Herein, the terms ‘unpaired spectrum’ and TDD may be used interchangeably, and still consistent with this disclosure.

Herein, the terms WTRU is configured, WTRU is indicated, WTRU receives configuration, and so forth, may indicate that the configuration is indicated for example via RRC, MAC-CE, DCI, MIB, or SIB, unless indicated otherwise, where for example, WTRU is configured may indicate WTRU is configured via RRC, MAC-CE, MIB, or SIB.

Herein, the terms target and candidate may be used interchangeably, and still consistent with this disclosure. For example, the terms target cell and candidate cell may be used interchangeably. In another example, the terms target beam and candidate beam may be used interchangeably.

Hereafter, the channel quality parameters may comprise the RSRP, however the embodiments and examples in the disclosure may equally (or equivalently or extendedly) be employed (e.g., applicable) for cases with other quality parameters and/or values (e.g., RSRQ, SINR, etc.).

A WTRU may receive configurations or configuration information (e.g., from a BS, gNB, a node, or a device) for full-duplex (FD) operation conducted by at least one device in a network. In an example, the FD operation may be conducted by a BS (e.g., a gNB, a node, a TRP, or a cell). The WTRU may operate in a half-duplex (HD) mode for communicating with the BS, where in the HD mode, at a given time, the WTRU may perform either an UL transmission or a DL reception (e.g., not both UL and DL simultaneously at the given time). The WTRU may (also) operate in an FD mode for communicating with the BS, for example if a corresponding WTRU capability signal(s) or information is reported to the BS and/or the WTRU receives a confirmation signal or information (e.g., enabling the FD, configuring the FD mode) in response to transmitting the WTRU capability signal(s) or information.

For FD operation, at a given time, a transmitter (e.g., the BS (e.g., gNB) and/or the WTRU) may simultaneously transmit a first signal and receive a second signal. The FD operation may comprise a subband overlapping FD (e.g., in-band FD (IBFD)) operation where a first frequency-domain resource (e.g., RBG(s), RB(s), RE(s) allocated for the first signal may have a full, or at least a partial, overlap with a second frequency-domain resource allocated for the second signal. The FD operation may comprise a subband non-overlapping FD (SBFD) operation where a first frequency-domain resource allocated for the first signal (e.g., assigned within a configured SBFD subband, for example, DL subband, usable DL physical resource blocks (PRBs)) does not have an overlap with a second frequency-domain resource allocated for the second signal (e.g., assigned within a configured SBFD subband, for example, UL subband, usable UL PRBs).

Hereafter, the FD operation may comprise the SBFD operation, however the embodiments and examples in this disclosure may equally (or equivalently or extendedly) be employed (e.g., applicable) for cases with other FD operation types (e.g., IBFD, etc.).

A WTRU may be configured with one or more types of slots within a bandwidth. A first type of slot may be used or determined for a first direction (e.g., downlink). A second type of slot may be used or determined for a second direction (e.g., uplink). A third type of slot may have a first group of frequency resources within the bandwidth for a first direction and a second group of frequency resources within the bandwidth for a second direction.

Herein, bandwidth may be interchangeably used with bandwidth part (BWP), carrier, subband, and system bandwidth; the first type of slot (e.g., the slot for a first direction) may be referred to as downlink slot; the second type of slot (e.g., slot for a second direction) may be referred to as uplink slot; the third type of slot may be referred to as Sub-Band (non-overlapping) Full Duplex (SBFD) slot; the group of frequency resource for a first direction may be referred to as downlink subband, downlink frequency resource, or downlink RBs; the group of frequency resource for a second direction may be referred to as uplink subband, uplink frequency resource, or uplink RBs; the group of frequency resource for a flexible direction (e.g., that can be configured for a first direction, second direction, etc.) may be referred to as flexible subband, flexible frequency resource, or flexible RBs; the group of frequency resources between a first direction and a second direction may be referred to as a guard band, guard frequency resource, or guard RBs.

In an example, a (SBFD-enabled) WTRU may receive or be configured with one or more SBFD UL or DL subbands in one or more DL, UL, and/or flexible TDD time instances (e.g., symbols, slots, frames, and so forth). The WTRU may be configured with one or more resource allocations for SBFD subbands.

For example, the SBFD configuration may include a flag signal or information (e.g., enabled/disabled), where for example a first value (e.g., zero (0)) may indicate a first mode of operation (e.g., based on SBFD resources and/or configurations), and a second value (e.g., one (1)) may indicate a second mode of operation (e.g., based on non-SBFD resources and/or configurations). The modes of operation (e.g., SBFD or non-SBFD) may be indicated via, for example a MIB, SIB, RRC, MAC-CE, or DCI, or other information element.

Herein, a WTRU operating based on SBFD operation may indicate the WTRU performing Tx/Rx based on SBFD resources and/or configurations. Herein, a WTRU operating based on non-SBFD operation may indicate the WTRU performing Tx/Rx based on non-SBFD resources and/or configurations.

The WTRU may receive information regarding the time resources (e.g., one or more symbols, slots, and so forth), for which the first mode of operation (e.g., SBFD) is defined in, for example, one or more BWPs, subbands, component carriers (CC), or cells. The WTRU may receive information regarding the frequency resources (e.g., subbands, BWPs, including one or more PRBs) within a (active and/or linked) BWP, for which the first mode of operation (e.g., SBFD) is configured. The time instances (e.g., slots, symbols) may be indicated based on periodic, semi-persistent, or aperiodic configurations. In an example, the time instances may be indicated via a bitmap configuration, where each bit may correspond to a time instance (e.g., slot, symbol, or subframe) and each bit indication may indicate whether a corresponding time instance may be used for the first or second mode of operation.

In an example, a WTRU may be configured with or receive configuration information regarding a DL TDD configuration for a component carrier (CC) or a BWP for one or more Rx occasions (e.g., via tdd-UL-DL-config-common, dedicated configurations, or slot format indicator (SFI)). If the first mode of operation (e.g., SBFD) is configured, one or more of the configured frequency resources (e.g., subbands, PRBs, and/or BWPs) may be configured for the transmission in UL channels and/or Tx occasions.

In an example, the WTRU may be configured with or receive configuration information regarding an UL TDD configuration for a component carrier (CC) or a BWP for one or more Tx occasions (e.g., via tdd-UL-DL-config-common, dedicated configurations, or slot format indicator (SFI). If the first mode of operation (e.g., SBFD) is configured, one or more of the configured frequency resources (e.g., subbands, PRBs, and/or BWPs) may be configured as the DL channels and/or Rx occasions.

In an example, the WTRU may be configured with a DL, UL, or flexible TDD configuration for a component carrier (CC) or a BWP for one or more Rx/Tx occasions (e.g., via tdd-UL-DL-config-common, dedicated configurations, or slot format indicator (SFI). If the first mode of operation (e.g., SBFD) is configured, one or more of the configured frequency resources (e.g., subbands, PRBs, and/or BWPs) may be configured for the first mode of operation (e.g., either UL transmission or DL reception based on the configurations).

The duplexing mode for the first mode of operation (e.g., SBFD configuration (UL/DL)) may be indicated via a flag indication, where for example a first value (e.g., zero (0) may indicate a first direction (e.g., UL duplexing mode), and a second the value (e.g., one (1) may indicate a second direction (e.g., DL duplexing model).

The duplexing mode configuration and/or flag for the first mode of operation (e.g., SBFD) may be configured as part of a modes of operation configuration, for example via a MIB, SIB, RRC, DCI, MAC-CE, or other information element.

The duplexing mode configuration and/or flag for the first mode of operation (e.g., SBFD) may be configured as part of a resource allocation configuration for a Tx/Rx occasion.

In an example, the WTRU may be configured with a downlink/uplink/downlink DUD configuration, where an UL subband is configured between two DL subbands, as shown in FIG. 2. In an example, the WTRU may be configured with an uplink/downlink UD configuration, where an UL subband is configured with higher frequencies followed by a DL subband with lower frequencies. In an example, the WTRU may be configured with a downlink/uplink DU configuration, where a DL subband is configured with higher frequencies followed by au UL subband with lower frequencies. These examples are non-limiting examples of the SBFD configurations and parameters that may be included in SBFD configurations. One or more of those configurations may be included. Other configurations may be included.

In an example, a WTRU may be configured with one or more types of slots. The WTRU may be configured with a first slot with a first type, where the first type may be for example a SBFD slot. The WTRU may be configured with a second slot with a second type, where the second type may be for example a non-SBFD slot. As for the first slot with the first type (e.g., SBFD), the WTRU may be configured with one or more DL, UL, flexible, or guard, subbands in the frequency domain, throughout the BWP, for the duration of the first slot. In the second slot with the second type (e.g., non-SBFD), the WTRU may be configured with a direction type, for example DL, UL, or flexible, in the frequency domain, throughout the BWP, for the duration of the second slot.

In an example, if the WTRU is configured with a second slot with an UL direction, this may indicate a legacy TDD UL slot, UL-only slot, and/or non-SBFD UL slot. In an example, if the WTRU is configured with a third slot with a second type (e.g., non-SBFD) with DL direction, this may indicate a legacy TDD DL slot, DL-only slot, and/or non-SBFD DL slot. In an example, if the WTRU is configured with a fourth slot with a second type (e.g., non-SBFD) with a flexible direction, this may indicate a legacy TDD flexible slot and/or non-SBFD flexible slot.

A WTRU may determine, identify, receive, be configured, and/or indicated to perform a cell switch from its serving cell to a determined, identified, configured, and/or indicated target cell. In an example, the WTRU may be in an RRC-Connected state. During the RRC-Connected state, the mobility of the WTRU may be handled and/or controlled by the network. During the RRC-Connected state, the connected WTRU may perform one or more radio resource management (RRM) measurements and report the RRM measurements, for example to its serving cell. The connected WTRU may receive a request, command, and/or indication to switch from the serving cell to a target and/or candidate neighboring cell.

A WTRU may receive, be configured, and/or indicated with a handover (HO) command from a serving cell. The (intra-NR) RAN handover preparation and execution may be performed based on one or more message exchanges, for example between BSs (e.g., gNBs). For example, the WTRU may determine, be configured, and/or indicated to reset the MAC entity and re-establish RLC, during a handover procedure triggered by RRC. In an example, during HO preparation, the source and target BSs may establish in-between user-plane (U-plane) tunnels. In an example, during HO execution, user data may be forwarded from a source BS to the target BS. In an example, the data forwarding from the source BS may continue until a user plane function (UPF) or the source BS's buffer is emptied.

A WTRU may receive, be configured, and/or indicated with a conditional handover (CHO) command from a serving cell. The WTRU may perform the configured and/or indicated CHO when one or more configured and/or indicated handover execution conditions are met. In an example, the WTRU may receive the HO conditions via RRC, where the WTRU may evaluate the configured and/or indicated execution conditions upon receiving the CHO configurations. For example, the WTRU may stop evaluating the conditions when the HO is accomplished or completed. For example, the WTRU may receive CHO configurations that may be generated by a serving and/or source cell in addition to CHO configurations that may be generated by candidate and/or neighboring cells. In an example, a CHO condition may include one or more trigger conditions, for example, based on one or more measured RSRP, RSRQ, RSSI, and/or SINR. If the WTRU determines that one or more of the CHO conditions for a candidate and/or target cell are satisfied, the WTRU may initiate HO to the corresponding target cell. In an example, the data forwarding between the source and target BSs may be accomplished before or after HO execution, which may be addressed as early or late data forwarding, respectively.

A WTRU may receive, be configured, and/or indicated to perform an L1/L2 triggered mobility (LTM) cell switch to a candidate cell and/or target cell. For example, the WTRU may receive, identify, be configured, and/or indicated to send (L1) (RRM) measurement reports, for example to a BS. The BS may change the WTRU's serving cell to a target and/or candidate cell, via an LTM cell switch command, for example signaled by MAC-CE signaling. As part of the cell switch command, the WTRU may receive an indication to an LTM candidate (pre) configuration, for example regarding an LTM target cell, where the WTRU may have received the (pre) configured configuration information, for example via semi-static configurations, for example, via RRC signaling. The WTRU may switch to the configured and/or indicated LTM target cell based on the received LTM cell switch command.

A WTRU may be configured and/or indicated to initiate UL timing advance (TA) acquisition before an LTM cell switching procedure, for example, as in a preparation phase. In an example, the WTRU may be indicated to send a PRACH transmission to one or more candidate cells, where the WTRU may receive the indication, for example by a PDCCH order. The WTRU may receive a TA command as part of an LTM cell switch command. In an example, the WTRU may be configured and/or indicated to measure TA.

Depending on the availability of a valid TA value, a WTRU may perform either a RACH-less LTM cell switch or RACH-based LTM cell switch. If the WTRU is provided with a valid TA value, for example in or with the cell switch command, the WTRU may apply the indicated TA value. In the case where a WTRU-based TA measurement is configured and the WTRU is not provided with a valid TA value in the cell switch command, the WTRU may apply the valid TA value by itself. Therefore, the WTRU may perform a RACH-less LTM cell switch upon receiving the cell switch command. If no valid TA value is available, the WTRU may perform a RACH-based LTM cell switch toward the indicated target cell. The WTRU may transmit the PRACH preamble indicated in the LTM cell switch command, based on an indicated SSB index and PRACH mask index.

In a RACH-less LTM, a WTRU may access a target cell using one or more configured and/or dynamic grants. For example, the WTRU may be (pre) configured with a configured grant (e.g., including corresponding time-domain resource allocations (TDRA), and frequency-domain resource allocations (FDRA)), for example via the LTM candidate configuration, for example, via RRC signaling. In an example, the WTRU may select the configured grant occasion associated with the beam indicated in the cell switch command (e.g., via indicated UL and/or DL TCI states). In an example, after an LTM cell switch to the target cell, the WTRU may start monitoring a PDCCH on the target cell for dynamic scheduling.

In an example, a WTRU performing a LTM cell switch procedure, for example triggered by a MAC CE, may reset the MAC entity, where the RLC and PDCP handling may be configured, for example via RRC configuration.

A WTRU may receive, be configured, and/or indicated with a conditional LTM cell switch command from a serving cell. The WTRU may perform the configured and/or indicated conditional LTM cell switch when one or more configured and/or indicated LTM cell switch conditions are met. In an example, the WTRU may receive the conditional LTM cell switch conditions via RRC signaling. The WTRU may evaluate the configured and/or indicated execution conditions upon receiving the conditional LTM cell switch configurations. For example, the WTRU may stop evaluating the conditions when the LTM cell switch is accomplished or completed. For example, the WTRU may receive conditional LTM cell switch configurations that may be generated by a serving and/or source cell in addition to conditional LTM cell switch configurations that may be generated by candidate and/or neighboring cells. In an example, a conditional LTM cell switch condition may include one or more trigger conditions, for example, based on one or more measured RSRP, RSRQ, RSSI, and/or SINR. If the WTRU determines that one or more of the conditional LTM cell switch conditions for a candidate and/or target cell are satisfied, the WTRU may initiate an LTM cell switch to the corresponding target cell. In an example, the data forwarding between the source and target BSs may be accomplished before or after the LTM cell switch, which may be addressed as early or late data forwarding, respectively.

Herein, the term LTM cell switch may interchangeably be used with HO, CHO, or conditional LTM cell switch, and still consistent with the disclosure.

Hereafter, the cell switching operation may comprise the LTM cell switching operation, however the embodiments and examples in this disclosure may equally (or equivalently or extendedly) be employed (e.g., be applicable) for cases with other cell switching operations (e.g., HO, CHO, or conditional LTM).

An L1 measurement herein may comprise a measurement of, for example, RSRP, RSRP, and/or RSSI, performed by a WTRU of a cell, beam, set of cells, or set of beams. Such L1 measurements may be similar to L3 measurements reported in RRM, with differences in, for example, filtering, reference signals measured, and/or reporting mechanisms.

L1 measurement may apply also to RRM reporting. Herein, measurements refer to L1 measurements for LTM. However, certain embodiments herein may apply also to RRM/L3 measurements, as well as other measurements (e.g., measurements of speed, location, height, and/or traffic).

Herein, reference is made to L1 measurement events, and L1 LTM mobility events, which may use separate reporting procedures, resources, and triggers. However, certain embodiments herein may also apply to any other type of measurement events of separate types which interact either in terms of the reporting procedures or the evaluation procedures.

LTM cell switch may apply also to any type of handover execution. Herein, the LTM cell switch refers to L1/2 triggered mobility whereby a preconfigured RRC configuration is applied when the WTRU receives an indication using, for example, a MAC CE or when a certain condition is met at the WTRU. However, certain embodiments may also apply to an RRC reconfiguration, an RRC conditional reconfiguration, as well as any other type of mobility procedure.

LTM execution trigger herein refers to a condition for performing LTM (e.g. a conditional handover trigger or measurement report trigger), which may be either configured or indicated by the network to the WTRU or estimated and/or determined by the WTRU.

A trigger may be based on any of the following. For example, a trigger may be based on time (e.g., absolute or relative time measured at the WTRU, SFN, or subframe number). For example, a trigger may be based on radio quality measurement or predicted radio quality for one or more of the serving cells or target cells (e.g., RSRP (beam or cell), RSRQ (beam or cell), cri-RI-PMI-CQI, cri-RI-i1, cri-RI-i1-CQI, cri-RI-CQI, cri-RSRP, ssb-Index-RSRP, cri-RI-LI-PMI-CQI). For example, a trigger may be based on a position (e.g., an area, for example defined by reference point and radius, or range of coordinates, or a distance threshold from a reference location). For example, a trigger may be based on L3 measurement events (e.g., Event A1 (serving cell becomes better than a threshold), Event A2 (serving cell becomes worse than a threshold), Event A3 (neighbor cell becomes an offset better than SpCell), Event A4 (neighbor cell becomes better than a threshold), Event A5 (SpCell becomes worse than threshold1 and neighbor cell becomes better than threshold2), Event A6 (neighbor cell becomes an offset better than Scell), Event B1 (Inter RAT neighbor becomes better than a threshold), Event B2 (Pcell becomes worse than threshold1 and inter RAT neighbor becomes better than threshold2). For example, a trigger may be based on an L1 measurement event or conditions, for example any event defined which utilizes L1 beam measurements to evaluate whether a criteria or condition is met. For example, LTM: Event LTM1: beam of serving cell becomes better than an absolute threshold; Event LTM2: beam of serving cell becomes worse than an absolute threshold; Event LTM3: beam of candidate cell becomes amount of offset better than beam of serving cell; Event LTM4: beam of candidate cell becomes better than an absolute threshold; Event LTM5: beam of serving cell becomes worse than absolute threshold1 and beam of candidate cell becomes better than another absolute threshold2. For example, a trigger may be based on time or location-based conditions, for example: time measured at the WTRU is within a duration from a threshold value; distance between the WTRU and a referenceLocation1 is above threshold1 and distance between the WTRU and a referenceLocation2 is below threshold2; distance between the WTRU and the serving cell moving reference location is above threshold1 and distance between the WTRU and a moving reference location is below threshold2. For example, a trigger may be based on a combination of L3, L1, time, location-based conditions or events. For example, a time measured at the WTRU is within a duration from a threshold value and a beam of a candidate cell becomes better than an absolute threshold value; distance between the WTRU and a referenceLocation1 is above threshold1 and the distance between the WTRU and a referenceLocation2 is below threshold2 and a beam of a candidate cell becomes an amount of an offset better than a beam of the serving cell; distance between the WTRU and the serving cell moving reference location is above threshold1 and the distance between the WTRU and a moving reference location is below threshold2 and a beam of the serving cell becomes worse than absolute threshold1 and a beam of a candidate cell becomes better than another absolute threshold2.

In a full duplex (FD) (e.g., SBFD) system, the potential effect of WTRU-to-WTRU and/or BS-to-BS (e.g., gNB-to-gNB) CLI should be considered in cell switching procedures. The network may need to perform CLI mitigation in the target cell and upon the WTRU's cell switching as part of the procedure. In an example, if the UL transmission from a WTRU that is switching to the target cell may cause CLI on the WTRUs in the target cell, the network may consider scheduling solutions (e.g., coordinated scheduling to avoid CLI between WTRUs) or power control methods.

An embodiment based on early SRS transmission via a first WTRU, as part of LTM cell switching, and before performing cell switching is proposed. The benefit of this embodiment is that the network may schedule WTRUs in the target cell to measure and report potential CLI caused by the first WTRU in advance. In this embodiment, the issue with semi-static configuration of SRS resources is addressed, where the triggering signaling includes one or more dynamic indications and/or configurations. As such, the WTRU may determine a second set of configurations for SRS transmission.

A WTRU may be connected to a serving cell. In an example, the WTRU may be in an RRC-Connected state. The WTRU may receive, identify, be configured, and/or indicated to report (L1) (RRM) measurement reports, for example based on one or more candidate cells. The WTRU may receive indication(s) (e.g., via MAC-CE or DCI), for example, from the serving cell, to change, configure, and initiate switching the WTRU's serving cell to the candidate cell, for example based on the reported measurements. In an example, the WTRU may receive one or more configuration information on one or more candidate cells (e.g., via RRC, MAC-CE, or DCI). For example, the WTRRU may receive the configuration information via RRC signaling. In an example, the WTRU may receive configuration information for LTM cell switching. For example, the WTRU may receive configuration information for a (pre) configured maximum number of (e.g., eight) candidate cells. In an example, the WTRU may receive configuration information for each configured candidate cell, for example including one or more of the following.

The configuration information may include a candidate cell ID. For example, the WTRU may receive a configured candidate cell's index, or identification.

The configuration information may include a candidate cell physical cell ID (PCI). For example, the WTRU may receive a configured candidate cell's PCI.

The configuration information may include a candidate cell RRC configuration. For example, the WTRU may receive one or more RRC configurations corresponding to the candidate cell, for example, via Itm-CandidateConfig.

The configuration information may include configurations on special modes of operation. In an example, the WTRU may receive configuration information on time and frequency resources where a special mode of operation is applied in the candidate cell. For example, the special mode of operation may be SBFD operation, cell DRX, or cell DTX. For example, the WTRU may receive configuration information on time and frequency resources where the special mode of operation is applied. In an example, the WTRU may receive configurations on the starting time, number of symbols, slots, and/or frames, where the configurations regarding the special mode of operation may be applied. In an example, the WTRU may receive configurations on the starting RB, RB offsets, number of RBs, subbands, BWPs, direction of transmission in different RBs, and/or guard bands, where the configurations regarding the special mode of operation may be applied.

The configuration information may include TCI states. For example, the WTRU may receive one or more second TCI states for LTM cell switch to the corresponding candidate cell. The configured TCI states may comprise UL, DL, and/or joint UL and DL TCI states.

The configuration information may include CSI report configurations. For example, the WTRU may receive one or more CSI report configurations including the resources for channel measuring (e.g., RSRP and/or RSRQ), report type to be periodic, aperiodic, or semi-persistent, periodicity, slot offset, number of reported cells, and/or number of reported RSs per cell.

The configuration information may include non-zero power (NZP) CSI-RS resource(s) and/or resource set(s). For example, the WTRU may receive configuration information on one or more NZP CSI-RS resources and/or NZP CSI-RS resource sets associated with the corresponding candidate cell for LTM cell switch.

The configuration information may include an SSB configuration. For example, the WTRU may receive one or more configuration information on the SSB associated with the candidate cell based on which the WTRU may perform RRM measurements for the corresponding candidate cell. In an example, the configuration on the SSB may include the frequency of the SSBs, SSB burst's periodicity, time domain position of the transmitted SSBs in an SSB burst (e.g., via ssb-PositionsInBurst), SSBs' subcarrier spacing, and/or SSB's secondary synchronization signal's (SS) energy per resource element (EPRE).

A WTRU may use the configured and/or indicated configurations for measuring one or more quality parameters (e.g., RSRP, RSRQ, SINR) based on one or more RSs (e.g., SSBs, CSI-RSs) from a candidate cell. In an example, the WTRU may measure the quality parameters based on one or more RSs from the candidate cell (e.g., SSB, CSI-RS). In an example, the WTRU may measure one or more L1-measurements. For example, the WTRU may initiate mobility reports in case one or more of the LTM events may be triggered. The report may include one or more measured quality parameters, TCI states, and/or one or more SSB indexes.

A WTRU may receive one or more first set of configuration information on one or more SRS transmission occasions. The first set of SRS configurations may be a semi-statically (pre) configured set. For example, the WTRU may receive the configuration information via RRC, MAC-CE, or DCI. In an example, the SRS configuration information may include one or more of the following example parameters: SRS resource set ID; SRS resource ID; resource type (e.g., periodic, aperiodic, semi-persistent) in addition to corresponding timing and periodicity configurations; SRS power control parameters (e.g., alpha, p0, path loss reference RS); SSB indexes and/or CSI-RS indexes (e.g., used as path loss reference, as TCI-state reference); number of SRS ports; transmission comb and/or corresponding cyclic shifts; time resource mapping (e.g., start position, number of symbols, repetition factor); frequency resource mapping (e.g., frequency domain position, shift, frequency hopping); spatial relation information; UL TCI states, and/or joint TCI states.

In addition to the above information, the SRS configuration may include one or more configuration information regarding TA configuration. In an example, the WTRU may receive configurations on one or more default and/or (pre) configured TA values. For example, the WTRU may be configured to use TA=0 as the default value. In an example, the WTRU may receive configuration information on a set of TA values, where different values of the TA may be included in the list. For example, the list may include one or more absolute TA values.

In an embodiment, a WTRU may receive one or more indications. The WTRU may use the received indications to determine one or more second set of configurations for SRS transmission to a candidate cell. In an example, the WTRU may receive the indications via DCI, MAC-CE, or RRC. For example, the WTRU may receive the indications via one or more PDCCH-orders. The one or more second set of configurations for SRS transmission (e.g. via a PCCH order) may be dynamic indications based on for example changes based on L1 measurements.

Hereafter, the dynamic indication may comprise the PDCCH order, however the embodiments and examples in the disclosure may equally (or equivalently or extendedly) be employed (e.g., applicable) for cases with other types of indications and/or configurations (e.g., DCI, MAC-CE, RRC).

In an example, the PDCCH order is used for a random access procedure initiation. For example, the PDCCH order indication may include one or more of the following: random access preamble index; UL/SUL indicator; SS/PBCH index; PRACH mask index; target cell indicator; PRACH association indicator; and/or PRACH retransmission indicator.

In an embodiment, in addition to the above information, a PDCCH order that is bundled, associated, and/or linked with a SRS transmission may include new information. One or more of the following example parameters may be included.

An SRS request field may be included. For example, the WTRU may receive the SRS resource ID and/or SRS configuration ID corresponding to the SRS resource to be transmitted to the target cell. The SRS request field (e.g. SRS resource ID) may be an indication or trigger to perform or transmit the indicated SRS.

An SSB index may be included. For example, the WTRU may receive the SSB index corresponding to the beam direction to be used for SRS transmission to the target cell. In an example, the indicated SSB index may be the same or different from the indicated SSB index in the PDCCH order to be used for PRACH preamble transmission.

An UL TCI-state may be included. For example, the WTRU may receive the UL TCI-state corresponding to the beam direction to be used for SRS transmission to the target cell. In an example, the indicated TCI-state may be the same or different from the indicated TCI-state in the PDCCH order to be used for PRACH preamble transmission.

A TA indication may be included. For example, the WTRU may receive one or more indications for determining the TA for SRS transmission towards the target cell. One or more of the following indications may be included. An indication to use (pre) configured and/or default TA may be included. For example, the WTRU may receive an indication to use the (e.g., default) configured TA value. In an example, the (e.g., default) configured TA value may be TA=0. A codepoint indication to use one of the TA values from the configured list of TA values in the corresponding SRS configuration may be included. An absolute value of the TA may be included. For example, the WTRU may receive an indication to determine the absolute value of the TA. In an example, the WTRU may receive a timing advance command (TAC) with a long format, where the received TAC indicates the absolute value of the TA. Information related to at least one WTRU behavior to adjust the TA based on the target cell's downlink reference timing may be included (e.g., the TA to be determined as if (or assuming that) the target cell (already) becomes the serving-cell). In an example, the WTRU may receive a TAC with a short format, where the WTR may use the TA adjustments along with (or in addition to) the TA used for UL transmissions in the serving cell, to determine the TA for SRS transmission toward the target cell, for example, based on the given information to adjust the TA based on the target cell's downlink reference timing (e.g., how to receive a TAC with short format).

A WTRU may determine a second set of SRS configurations. In an example, if the cell ID indicated via the received PDCCH order is regarding a target, candidate, non-serving cell, the WTRU may determine one or more second SRS configurations based on the received PDCCH order. For example, if the cell ID indicated via the PDCCH order is different from the serving cell's ID, the WTRU may determine one or more second SRS configurations based on the received PDCCH order.

In an example, the WTRU may determine one or more of the following second configurations.

The WTRU may determine a spatial filter. For example, the WTRU may use the indicated SSB index and/or TCI state received in the PDCCH order and/or as part of the SRS configuration corresponding to the target cell, for determining a second UL TCI state and/or the second UL spatial filter for SRS transmission toward the target cell.

The WTRU may determine an SRS power. For example, the WTRU may use the indicated SSB index in the PDCCH order as the reference for estimating the path loss for calculating or determining a second SRS power for SRS transmission toward the target cell.

The WTRU may determine a TA value. For example, the WTRU may determine a second TA to be used for SRS transmission towards the target cell, based on the indication received in the PDCCH order. One or more of the following may apply. If no indication on TA is received, the WTRU may use the (pre) configured and/or default TA value (e.g., TA=0). If the indication on TA is received and the indication indicates to use the default TA value, the WTRU may use the (pre) configured and/or default TA value (e.g., TA=0). If the indication includes a codepoint, the WTRU may use the codepoint to select the TA based on a configured list of TA values. If TAC based on a long format is received, the WTRU may use the TAC for determining the absolute value of the TA. If TAC based on a short format is received, the WTRU may apply the TAC adjustments to the UL TA in the serving cell to find the second TA to be used for SRS transmission to the target cell.

The WTRU may transmit the SRS toward the target cell based on the determined second set of configurations.

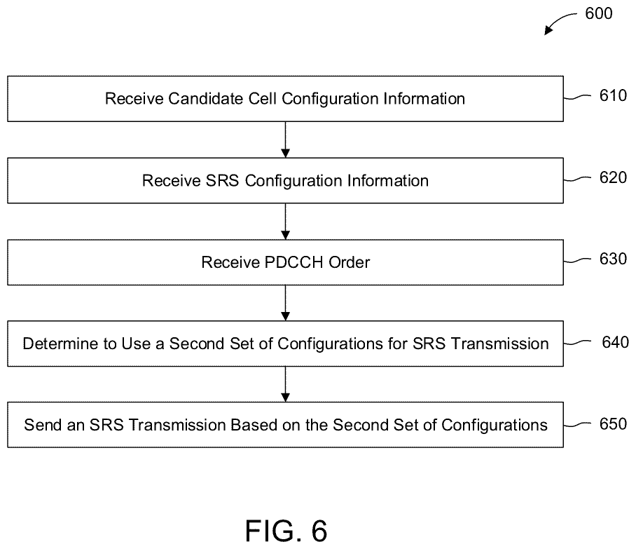

FIG. 6 shows an example procedure 600 for early SRS transmission in an LTM system.

A WTRU may receive candidate cell configuration information 610. The WTRU may be in an RRC_Connected state. The WTRU may be connected to a serving cell. The candidate cell configuration information may be received from a network entity (e.g. BS or gNB). The candidate cell configuration information may be received via, for example RRC signaling, a MAC CE, or a DCI. The candidate cell configuration information may comprise information regarding one or more candidate cells for a LTM cell switching procedure. The configuration information may comprise one or more indications. The indications may be received in one or multiple configuration information messages. The indications may be for the WTRU to measure and report one or more L1-measurements based on, for example SSBs, from one or more candidate cells. The candidate cell configuration information may comprise an indication of a number of candidate cells (e.g. a maximum number of candidate cells). The candidate cell configuration information may comprise information for each of the candidate cells. For example, the candidate cell configuration information may comprise: a candidate cell ID, a candidate cell PCI, a candidate cell RRC configuration, a configuration regarding a special mode of operation, a TCI state, a CSI reporting configuration, a NZP CSI-RS resource(s) and/or resource set(s), and/or an SSB configuration. The WTRU may use the candidate cell configuration information to measure one or more quality parameters (e.g., RSRP, RSRQ, and/or SINR) based on one or more RSs (e.g., SSBs and/or CSI-RSs) from a candidate cell.

The WTRU may receive SRS configuration information 620. The SRS configuration information may be received from a network entity (e.g. BS/gNB). The configuration information may be received via, for example RRC signaling, a MAC CE, or a DCI. The SRS configuration information may be semi-statically (pre) configured SRS information. The configuration information may comprise information regarding one or more SRS resources and/or SRS resource sets. The SRS configuration information may comprise one or more indications. For example, the SRS configuration information may comprise: an SRS resource set ID, an SRS resource ID, a resource type, SRS power control parameters, a first SSB index, a CSI-RS index, a number of SRS ports, a transmission comb, a cyclic shift, a time resource mapping information, a frequency resource mapping information, periodicity, slot offset, power control configuration, a first UL TCI state, and/or spatial relation information. The SRS configuration may include one or more configuration information regarding TA configuration. For example, the SRS configuration information may indicate one or more default and/or (pre) configured TA values. The SRS configuration information may indicate a set of TA values, where different values of TA may be included in a list. For example, the list may include one or more absolute TA values. The WTRU may be configured to use TA=0 as a default value. The candidate cell configuration information and the SRS configuration information may be received in a same message or different messages.

The WTRU may receive one or more (dynamic) indications for determining one or more second configurations (e.g. set of configurations) for SRS transmission to a candidate cell 630. The one or more indications may be in a PDCCH message or order (e.g. one or more PDCCH orders). The PDCCH order may be received from a network entity (e.g. BS/gNB). The PDCCH order may be received via, for example a DCI, MAC CE, or RRC signaling. The PDCCH order may include information for random access procedure initiation. The PDCCH order may be bundled, associated, and/or linked with an SRS transmission. The PDCCH order may comprise, for example: a target cell ID, an SRS request field indicating a triggered SRS resource ID (corresponding to the SRS resource to be transmitted to the target cell), a TA value, a second SSB index and/or a second UL TCI-state. The SRS request field may indicate/request/trigger an SRS transmission. The SRS transmission may correspond to the indicated SRS resource ID.

The WTRU may determine a second set of configurations to use for SRS transmission to the target cell 640. The WTRU may determine the second set of configurations to use for SRS transmission based on the cell ID in the received PDCCH order being a cell ID for a target cell, a candidate cell, or a non-serving cell (i.e. different than the serving cell ID). For example, the WTRU may determine the second set of configurations to use for SRS transmission if the indicated target cell ID is different from the serving cell ID. The WTRU may determine the second set of configurations to use for SRS transmission based on the received PDCCH order (i.e. indications in the PDCCH order).

The WTRU may determine a spatial filter to use for SRS transmission to the target cell. The WTRU may use the SSB index (e.g. second SSB index) and the UL TCI state (e.g. second UL TCI state) in the PDCCH order for determining an UL spatial filter to use for SRS transmission to the target cell (e.g. second UL spatial filter).

The WTRU may determine an SRS power (e.g. second SRS power) to use for SRS transmission to the target cell. The WTRU may use the SSB index in the PDCCH order (e.g. second SSB index) and/or the L1 measurements (e.g., measured RSRP) for determining a path loss estimation (e.g. second path loss estimation) for calculating or determining the second SRS power for SRS transmission to the target cell.

The WTRU may determine a TA (e.g. second TA) to be used for SRS transmission to the target cell. The WTRU may determine the TA to be used for SRS transmission to the target cell based on information in the PDCCH order. For example, if no indications regarding the TA is provided in the PDCCH order, the WTRU may determine the TA to be a (pre) configured default value (e.g., TA=0). If a codepoint is provided in the PDCCH order, the WTRU may determine the TA according to a (pre) configured list of TA values. If a TA absolute value is provided in the PDCCH order, the WTRU may use the provided TA absolute value.

The WTRU may send an SRS transmission 650 to the target cell. The WTRU may send the SRS transmission based on at least the determined one or more second configuration (e.g. indicated SRS resource, determined TA, determined power, and the determined UL spatial filter).

Based on the transmitted SRS from the first WTRU, the target cell may configure and/or indicate to one or more WTRUs in the target cell to measure and report the measured CLI. The target cell may determine the CLI that may be caused by the first WTRU upon switching to the target cell. As such, the target WTRU may determine the mode of operation for the first WTRU. The target cell may indicate the mode of operation (e.g., via backhaul) to the serving cell. As such, the first WTRU may receive one or more of the following indications (e.g., from the serving cell, for example, via RRC, MAC-CE, or DCI) regarding the cell switching to the target cell.

The first WTRU may receive information indicating a target cell barred for cell switching. In an example, the WTRU may receive an indication that the cell switching to the corresponding target cell may be barred for the WTRU. That is, the WTRU may not be allowed to switch to the target cell. In other words, the target cell may be barred and/or disabled for the WTRU to connect to. In an example, the WTRU may determine, receive, be configured, and/or indicated with one or more time-windows during which the target cell may be barred for the WTRU. That is, the WTRU may not measure RSs from the target cell, or the WTRU may not send reports regarding the target cell (e.g., to the serving cell) during the corresponding time window. In an example, the WTRU may consider the target cell as barred until a second indication is received, where the second indication may indicate that the target cell may not be barred anymore. In an example, the WTRU may be configured to consider the target cell as un-barred, enabled, allowed, and/or available after receiving the second indication. In an example, the second indication may indicate a time instance after which the target cell may not be barred anymore for the WTRU. For example, the time instance may be based on absolute time units (e.g., msec, usec, etc.) and/or based on the number of time instances (e.g., symbols or slots). After the WTRU determines or receives an indication that the target cell is not barred anymore, the WTRU may measure one or more parameters based on one or more determined and/or configured RSs from the target cell and/or report the measured parameters.

The first WTRU may receive information indicating to operate based on SBFD. In an example, the WTRU may receive an indication that after switching to the corresponding target cell, the WTRU may be allowed and/or enabled to operate based on SBFD configurations. That is, the WTRU may be allowed and/or enabled to use SBFD resources, SBFD symbols, UL, DL, or flexible subbands, and/or SBFD ROs.

The first WTRU may receive information indicating to operate based on non-SBFD. In an example, the WTRU may receive an indication that after switching to the corresponding target cell, the WTRU may not be allowed and/or may be disabled to operate based on SBFD configurations. That is, the WTRU may be allowed and/or enabled to use non-SBFD resources, non-SBFD symbols, UL-only, DL-only, flexible symbols, and/or non-SBFD ROS.

A WTRU may be configured to transmit an SRS towards a target cell. The WTRU may be configured to perform one or more of the following.

For example, the WTRU may receive one or more first indications and/or signaling (e.g., via DCI, MAC CE, or RRC signaling) (e.g., PDCCH-order) indicating the WTRU to send one or more PRACH preambles to one or more target cells. The WTRU may receive the target cell ID, the PRACH preamble to be used, and the SSB index to be used. The WTRU may send the indicated PRACH preamble toward the indicated target cell.

In an example, the WTRU may also receive a first indication (e.g., as part of the received PDCCH-order) to send one or more SRS based on or more indicated and/or configured SRS configurations, toward the target cell. If the first indication includes an indication on the TA to be used for UL transmission in the target cell, the WTRU may use the indicated TA for SRS transmission. If the first indication does not include the TA to be used, the WTRU may use a (pre) configured and/or a default value for the SRS transmission (e.g., TA=0).

In an example, upon reception of the transmitted PRACH preamble, the target cell may determine the TA and may indicate the determined TA to the serving cell (e.g., via backhaul).

In an example, after the PRACH preamble transmission, the WTRU may receive a random access response (RAR) (e.g., from the target cell or the serving cell) indicating the TAC for configuring the TA for UL transmission towards the target cell. The WTRU may use the indicated TAC to determine the TA for SRS transmission towards the target cell.

In an example, the WTRU may receive a second indication (e.g., via DCI, MAC CE, or RRC signaling) (e.g., PDCCH-order), where the second indication may indicate the WTRU to send an SRS to the target cell based on an indicated TA value (e.g., TA>0). The WTRU may send the configured SRS toward the target cell (e.g., based on TCI-state towards the target cell).

In an example, the WTRU may receive one or more configuration information and/or indications on one or more SRS configurations to be transmitted toward a target cell. The WTRU may receive the configurations and/or indications as part of the MAC CE signaling used for triggering the LTM cell switching. That is, upon receiving the MAC CE signaling triggering the LTM cell switching, the WTRU may determine that the MAC CE is also triggering the SRS transmission toward the target cell. The WTRU may transmit the configured SRS after performing the cell switching to the target cell.

A WTRU may determine, be configured, and/or indicated to transmit one or more SRS based on one or more configured SRS configurations, for example as part of LTM cell switching. One or more of the following example scenarios may apply.

In an example UL-based TA determination scenario, a WTRU may not be capable to measure and/or estimate the TA based on received DL signals and/or channels. For example, the WTRU may report this incapability as part of WTRU capability reporting. As such, the WTRU may require to be provided with TA values for UL transmissions (e.g., PRACH Tx or SRS Tx). That is, the WTRU may require UL-based TA to be determined at the network (e.g., in a BS/gNB) and then to be indicated to the WTRU. The same may apply for UL transmission towards a target cell. That is, the WTRU may receive and measure one or more DL RSs (e.g., SSBs or CSI-RS) from the target cell. However, the WTRU may not be able to measure and/or determine the TA towards the target cell based on the received DL RSs. As such, if the WTRU receives an indication for one or more SRS transmission (e.g., PDCCH-order) (e.g., via DCI, MAC-CE, or RRC signaling), and if the TA configuration is absent in the indications, the WTRU may use a (pre) configured and/or default TA value (e.g., TA=0) for the corresponding SRS transmission.

In an example, in an LTM cell switching operation, the WTRU may receive a request (e.g., from a BS/gNB) (e.g., via DCI, MAC-CE, or RRC signaling) for SRS transmission towards a target cell. For example, the WTRU may receive the SRS Tx request as part of LTM cell switching triggering (e.g., MAC CE) signaling. In an example, the SRS Tx request indication may include the TA to be used for SRS transmission towards the target cell.

In an example, in a conditional LTM cell switching procedure, the WTRU may receive a RAR in response to one or more transmitted PRACH preambles. For example, the PRACH transmission may be towards a target cell. In an example, the WTRU may be configured to receive the RAR from the target cell within a configured time window or in one or more configured and/or indicated time and frequency resources. In an example, the WTRU may receive the RAR from the serving cell (e.g., based on the data communication between the serving cell and the target cell, for example, via backhaul). In an example, the WTRU may receive one or more configuration information based on a configured and/or dynamic grant, for example including the determined TA. In an example, the WTRU may receive a separate indication from the target cell or the serving cell including a TAC (e.g., via PDCCH, PDSCH, DCI, MAC CE, or RRC signaling).

In an example DL-based TA determination scenario, a WTRU may be capable of measuring, determining, and/or estimating the TA based on one or more received DL signals and/or channels. For example, the WTRU may report this capability as part of WTRU capability reporting. That is, the WTRU may receive and/or measure one or more DL RSs (e.g., SSBs or CSI-RS) from a target cell. The WTRU may measure and/or determine the TA towards the target cell based on the received DL RSs.

In an example, in an LTM cell switching operation, the WTRU may receive a request (e.g., from a BS/gNB) (e.g., via DCI, MAC-CE, or RRC signaling) for SRS transmission towards a target cell. As such, the WTRU that is capable of determining the TA may not need to receive a PDCCH order for SRS transmission. In an example, the WTRU may receive, be configured, and/or indicated with a new SRS configuration information element (IE) (e.g., LTMSRS-Config), where the new IE may include one or more of the following parameters: SRS resource ID, SRS resource set ID, time and frequency mapping for the SRS transmission, transmission comb, and/or sequence. Additionally, the new SRS configuration (e.g., to be used for LTM CLI mitigation) may include a target cell's ID, TCI state, SSB index, TA value, and/or SRS power configurations. As such, after receiving the indication for transmitting the SRS, the WTRU may use the configured SRS configurations for the corresponding SRS transmission.

In an example, in a conditional LTM cell switching operation, the WTRU may receive, be configured, and/or indicated with one or more conditions and/or events for one or more SRS transmissions, that is event-based SRS transmission. In an example, the WTRU may be configured with one or more SRS configurations (e.g., LTMSRS-Config).

In an example, the WTRU may be configured with one or more first set of (e.g., L1) (e.g., LTM) events and or conditions for triggering one or more measurement, reporting, and/or LTM triggered cell switching. That is, if one or more of the first conditions are satisfied and/or if one or more of the configured first events are triggered, the WTRU may perform the cell switching. In an example, the WTRU may be configured with one or more second set of (e.g., L1) (e.g., LTM) events and or conditions for triggering the SRS transmission toward the target cell. That is, if one or more of the second conditions are satisfied and/or if one or more of the configured second events are triggered, the WTRU may transmit the configured SRS based on the SRS configurations.

In an example, the WTRU may be configured with an event (e.g. event LTM4), that is the beam (e.g., TCI-state) of the candidate cell becomes better than the absolute first RSRP threshold. The WTRU may be configured with a first RSRP threshold to be used for evaluating the event LTM4. As such, if event LTM4 is triggered, the WTRU may perform measurements, reporting, and/or LTM cell switching.

In an example, the WTRU may be configured with an event (e.g. event SRS-LTM4), that is the beam (e.g., TCI-state) of the candidate cell becomes better than the absolute second RSRP threshold. The WTRU may be configured with a second RSRP threshold to be used for evaluating the event SRS-LTM4, where the second RSRP threshold may be lower than the first RSRP threshold. As such, if event SRS-LTM4 is triggered, the WTRI may transmit the configured SRS toward the target cell.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU) connected to a serving cell, the method comprising:
receiving a first message comprising at least a candidate cell identification (ID) and a synchronization signal block (SSB) configuration for a candidate cell;
receiving a second message that comprises a first set of sounding reference signal (SRS) configurations;
receiving a third message over a physical downlink control channel (PDDCH) channel, wherein the third message comprises at least a target cell ID, an SRS resource ID, an uplink transmission configuration index (TCI) state, an indication of a timing advance (TA), and a synchronization signal block (SSB) index;
determining a second set of SRS configurations based on the third message and based on the target cell ID being different than a cell ID of the serving cell, wherein the second set of SRS configurations comprises at least an uplink spatial filter, an SRS power, and a TA; and
sending, to a target cell, based on the third message, an SRS transmission, using the determined second set of SRS configurations.

2. The method of claim 1, wherein the SRS transmission to the target cell is performed before cell switching is performed.

3. The method of claim 1, further comprising:
performing a L1/L2 mobility (LTM) cell switch, based on the received first message, subsequent to sending the SRS transmission to the target cell.

4. The method of claim 1, wherein the third message comprises a request for the WTRU to send an SRS transmission to the target cell.

5. The method of claim 1, wherein the indication of a TA in the third message comprises an indication to use a preconfigured TA value.

6. The method of claim 1, wherein the indication of a TA in the third message comprises a codepoint to a TA value from a list of TA values.

7. The method of claim 1, wherein the indication of a TA in the third message comprises a timing advance command (TAC) that indicates an absolute value of the TA.

8. The method of claim 1, wherein the uplink spatial filter is determined based on an estimated path loss which is based on the SSB index.

9. The method of claim 1, wherein the SRS power is determined based on at least one of: the SSB index or the uplink TCI state.

10. The method of claim 1, wherein the TA in the determined second set of SRS configurations is determined based on the indication of the TA in the received third message.

11. A wireless transmit/receive unit (WTRU) connected to a serving cell, the WTRU comprising:
a receiver;
a processor; and
a transmitter, wherein:
the receiver is configured to receive a first message comprising at least a candidate cell identification (ID) and a synchronization signal block (SSB) configuration for a candidate cell;
the receiver is further configured to receive a second message that comprises a first set of sounding reference signal (SRS) configurations;
the receiver is further configured to receive a third message over a physical downlink control channel (PDDCH) channel, wherein the third message comprises at least a target cell ID, an SRS resource ID, an uplink transmission configuration index (TCI) state, an indication of a timing advance (TA), and a synchronization signal block (SSB) index;
the processor is configured to determine a second set of SRS configurations based on the third message and based on the target cell ID being different than a cell ID of the serving cell, wherein the second set of SRS configurations comprises at least an uplink spatial filter, an SRS power, and a TA; and
the transmitter is configured to send, to a target cell, based on the third message, an SRS transmission, using the determined second set of SRS configurations.

12. The WTRU of claim 11, wherein the SRS transmission to the target cell is performed before cell switching is performed.

13. The WTRU of claim 11, wherein the processor is further configured to perform a L1/L2 mobility (LTM) cell switch, based on the received first message, subsequent to sending the SRS transmission to the target cell.

14. The WTRU of claim 11, wherein the third message comprises a request for the WTRU to send an SRS transmission to the target cell.

15. The WTRU of claim 11, wherein the indication of a TA in the third message comprises an indication to use a preconfigured TA value.

16. The WTRU of claim 11, wherein the indication of a TA in the third message comprises a codepoint to a TA value from a list of TA values.

17. The WTRU of claim 11, wherein the indication of a TA in the third message comprises a timing advance command (TAC) that indicates an absolute value of the TA.

18. The WTRU of claim 11, wherein the uplink spatial filter is determined based on an estimated path loss which is based on the SSB index.

19. The WTRU of claim 11, wherein the SRS power is determined based on at least one of: the SSB index or the uplink TCI state.

20. The WTRU of claim 11, wherein the TA in the determined second set of SRS configurations is determined based on the indication of the TA in the received third message.
